(19) United States
(12) Patent Application Publication
(10) Pub. No.: US 2015/0358686 A1
(43) Pub. Date: Dec. 10, 2015

(54) CODE RATE SMOOTHING METHOD FOR TRANSMITTING REAL-TIME VIDEO IN A WIRELESS NETWORK

(71) Applicant: BEIJING XINWEI TELECOM TECHNOLOGY INC., Beijing (CN)

(72) Inventors: Yan XU, Beijing (CN); Zhengchun XU, Beijing (CN); Xiao WU, Beijing (CN); Xiaohua LI, Beijing (CN)

(73) Assignee: Beijing Xinwei Telecom Technology Iinc., Beijing (CN)

(21) Appl. No.: 14/759,273

(22) PCT Filed: Jun. 28, 2013
(86) PCT No.: PCT/CN2013/078356

§ 371 Date: Jul. 6, 2015

(30) Foreign Application Priority Data
Jan. 8, 2013 (CN) 201310006416.X

(51) Int. Cl. H04N 21/6373; H04W 28/02; H04N 21/2187; H04N 21/238; H04N 21/2383

(52) U.S. Cl. CPC H04N 21/6373; H04N 21/23805; H04N 21/2383; H04N 21/2187; H04W 28/0289

(57) ABSTRACT

The present disclosure provides a code rate smoothing method for transmitting real-time video in a wireless network. The method may include the following. Make a statistics on transmission delay of a video frame periodically. When the transmission delay becomes smaller, size of playing buffer may be adjusted to be smaller by fast forwarding. When the transmission delay becomes larger, size of playing buffer may be adjusted to be larger by slow playing. Rates of fast forwarding and slow playing may be determined by variation of transmission delay, depth of playing buffer and timestamp information.

This application claims priority to a Chinese patent application No. 201310006416.X, titled “code rate smoothing method for transmitting real-time video in wireless network”, which was filed on Jan. 8, 2013. The disclosures of the application No. 201310006416.X are incorporated here by reference.

### TECHNICAL FIELD

The present disclosure relates to wireless communication technologies, and more particularly, to a code rate smoothing method for transmitting real-time video in a wireless network.

### BACKGROUND

For applications with higher real-time requirements at present, such as video conference, a method of directly playing a video frame immediately after receiving the video frame may be generally employed. The foregoing method focuses on real-time performance. However, when transmitting video in a wireless network, instantaneous code rate may become at least two times of average code rate due to some larger video frames (such as I frame). A large amount of burst data may easily lead to network congestion. Longer time is needed to transmit these frames. Subsequently, obvious jitter may occur when transmitting video frames. Under the circumstances, video pause may occur periodically, when receiver still employs the method of displaying a video frame immediately after receiving the video frame, which may have a serious impact on fluency of video and subjective video experience.

To overcome instability resulted from reasons, such as changes of wireless channel, a traditional streaming media system may adopt a method of buffering frames, so as to use some playing delay to exchange for fluency of video. In such method, a playing buffer may be used to buffer received media data. When playing streaming media, the received media data may be firstly put into the buffer. And then the streaming media may be played based on timestamp information, when data amount in the buffer achieves a certain threshold. Under the circumstances that channel conditions become worse and underflow occurs in the buffer, playing may be paused, so as to wait for data amount in the buffer achieves a specified threshold to implement continued playing. When there is more buffered data, it is obvious that playing interruption of client, which is resulted from packet loss, packet delay, jitter, etc., may be effectively reduced by using such method.

However, the foregoing method may not make a statistics on network transmission delay, and may not perform a dynamic adjustment to buffer size. Inconsistence of storing data rate and reading data rate may easily lead to larger change of buffer size. Subsequently, the phenomenon of full buffer or empty buffer (all the data in the buffer has been played) may occur, which may lead to disfluency of video playing. That is, under the circumstances of small transmission delay and good network condition, data amount in the buffer cannot be adjusted to be smaller, thereby introducing unnecessary buffer time and generating relatively large delay during playing. Thus, it is difficulty to guarantee real-time performance of video transmission. Under the circumstances of poor network condition, data amount in the buffer cannot be dynamically adjusted to be larger, which may easily lead to empty buffer (that is, all the data in the buffer has been played) and playing pause, thereby affecting users' experience. Subsequently, it is difficulty to guarantee smoothness of video transmission.

### SUMMARY

In view of above, various examples of the present disclosure provide a code rate smoothing method for transmitting real-time video in a wireless network, which may implement balance of real-time performance and fluency of video stream.

To achieve the foregoing objectives, the technical solutions of the present disclosure may be implemented as follows.

A code rate smoothing method for transmitting real-time video in a wireless network, including:

making a statistics on transmission delay of a video frame;

when the transmission delay becomes smaller, adjusting a size of a playing buffer to be smaller by fast forwarding;

when the transmission delay becomes larger, adjusting the size of the playing buffer to be larger by slow playing;

wherein rates of the fast forwarding and the slow playing are determined by variation of the transmission delay, depth of the playing buffer and timestamp information.

Thus, it can be seen that, by employing the method of the present disclosure, it may make a statistics on transmission delay of video frame periodically, and sense changes of wireless network's state based on statistical result, so as to dynamically adjust buffer size, and find the best playing delay to achieve smoothing effects. Thus, balance of real-time performance and fluency of video stream may be implemented.

### BRIEF DESCRIPTIONS OF DRAWINGS

To enable one with ordinary skill in the art to be clear with features and advantages of the present disclosure, examples of the present disclosure will be described in detail in the following, accompanying with attached figures. In the attached figures:

FIG. 1 is a flowchart illustrating a code rate smoothing method for transmitting real-time video in a wireless network, in accordance with an example of the present disclosure.

FIG. 2 is a flowchart illustrating decoding and storing executed by a receiver device B, in accordance with an example of the present disclosure.

### DETAILED DESCRIPTIONS

For the challenges in the prior art, the present disclosure provides a code rate smoothing method for transmitting real-time video in a wireless network. Based on playing buffer mechanism, changes of wireless network's state may be sensed dynamically by making a statistics on transmission delay of video frame periodically, so as to dynamically adjust size of playing buffer, and find the best playing delay to achieve the smoothing effects. Subsequently, balance of real-time performance and fluency of video stream may be implemented. That is, under the circumstances that the fluency is guaranteed, a relatively small playing delay may be used, when network state is better; and a relatively large playing delay may be used, when the network state is worse.

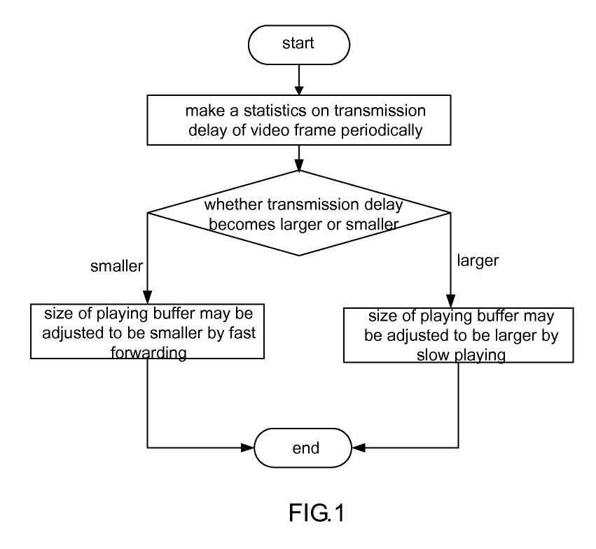

FIG. 1 is a flowchart illustrating a code rate smoothing method for transmitting real-time video in a wireless network, in accordance with an example of the present disclosure. As shown in FIG. 1, make a statistics on transmission delay of video frame periodically. When the transmission delay becomes smaller, it may denote that network state is better. And then, size of playing buffer may be adjusted to be smaller by fast forwarding, so as to reduce playing delay. When the transmission delay becomes larger, it may denote that the network state is worse. And then, size of the playing buffer may be adjusted to be larger by slow playing, so as to avoid video pause resulted from empty buffer (all the video frames in the buffer have been played). Size of the playing buffer may be determined by difference of data amount of writing buffer and reading buffer. Reading rate is controllable. Fast forwarding or slow playing may be executed. Thus, in the present disclosure, size of playing buffer may be adjusted through fast forwarding or slow playing. Speeds of fast forwarding and slow playing may be co-determined by change of transmission delay, depth of playing buffer and timestamp information. Such adjustment considers factors of change of transmission delay and depth of playing buffer. Larger size of playing buffer may denote that data amount currently buffered is closer to the maximum buffer value, and fast forwarding is more needed, so as to ensure that there is enough space in the buffer to accommodate subsequent data. On the contrary, smaller size of playing buffer may denote that data amount currently buffered is smaller, and slow playing is more needed, so as to ensure a non-empty buffer.

Based on the foregoing descriptions, it can be seen that, in the method provided by various examples of the present disclosure, it may make a statistics on transmission delay of video frame periodically. The following methods may be used each time when making a statistics periodically. The statistical value of transmission delay

$$D = \frac{{\sum }_{i = 1}^{N} {a}_{i} {D}_{i}}{N}$$

may be obtained by averaging weighted transmission delay of each video frame arrived within recent time T. Dᵢ may be transmission delay of each video frame arrived within recent time T. aᵢ (i=1, 2, . . . , N) may be a weight factor. N may denote number of video frames arrived within recent time T. And T may denote size of a preset statistical time window. In practical applications, other methods may also be employed to make a statistics on transmission delay of video frame, as long as changes of wireless network's state may be reflected.

After making a statistics on transmission delay of each period, state of wireless network before arrival of a next period may be estimated, by using statistical transmission delay D_{curr} of recent period and statistical transmission delay Dₗₐₛₜ of last period (or, previous period in other words). Compare statistical transmission delay D_{curr} of recent period with statistical transmission delay Dₗₐₛₜ of last period. When D_{curr}>Dₗₐₛₜ, it may denote that transmission delay becomes larger, and state of network may become worse. Thus, it is necessary to dynamically increase size of playing buffer. When Dₗₐₛₜ>D_{curr} it may denote that transmission delay becomes smaller, and network state may become better. Thus, it is necessary to dynamically reduce size of playing buffer. Other methods may also be employed to determine changes of transmission delay. For example, statistical transmission delay of previous K periods may be used to execute comparison and determination, and so on.

To better satisfy subjective video experience, size of playing buffer may be respectively increased and reduced by slow playing and fast forwarding of small granularity. Based on experience value, rate variation may not be sensed, when human visual characteristics change within an interval range of 25% playing time. Thus, rates of fast forwarding and slow playing may change within a range of 25% timestamp-based playing rate. That is, range of rate r_{slow} of slow playing is (0.75 rₙₒᵣₘₐₗ rₙₒᵣₘₐₗ). Range of rate r_{fast} of fast forwarding is (rₙₒᵣₘₐₗ, 1.25 rₙₒᵣₘₐₗ). rₙₒᵣₘₐₗ may denote the timestamp-based playing rate. Based on practical conditions, change may also be available within a larger or smaller percentage range.

Within the foregoing 25% adjustment range, furthermore, rate of slow playing may be r_{s10w}=(1−0.25 pq_{slow})rₙₒᵣₘₐₗ. Rate of fast forwarding may be r_{fast}=(1+0.25 pq_{fast})rₙₒᵣₘₐₗ. P is a factor reflecting variation of transmission delay.

$$p = \{ \begin{matrix}\vert \frac{{D}_{curr} - {D}_{last}}{{D}_{last}} \vert , \vert {D}_{curr} - {D}_{last} \vert < {D}_{last} \\ 1 , \vert {D}_{curr} - {D}_{last} \vert \geq {D}_{last}\end{matrix} .$$

q is a factor reflecting depth of playing buffer. Take into account of influences on fast forwarding and slow playing generated by size of playing buffer, a factor reflecting depth of playing buffer of slow playing is

$${q}_{slow} = 1 - \frac{buffer\_num}{buffer\_max} .$$

A factor reflecting depth of playing buffer of fast forwarding is

$${q}_{fast} = \frac{buffer\_num}{buffer\_max} . buffer\_num$$

may denote size of current playing buffer. buffer_max may denote a predetermined maximum size of playing buffer. Factors, such as frame rate, buffer time, storage space may be taken into consideration, when setting the value of buffer_max. Larger playing delay may be resulted from larger value of buffer_max. Subsequently, real-time performance of video playing may be affected. Effects of buffer may be not obvious, when value of buffer_max is too small. Thus, it is necessary to reasonably set the value of buffer_max.

The foregoing fast forwarding and slow playing may be used to adjust playing interval of two adjacent frames. For example, under the circumstances that the timestamp-based playing is executed, playing interval of two adjacent frames is ΔTₜₛ. When adjustment is executed by fast forwarding and slow playing, for the 25% of adjustment range, adjustment range of each frame may be 0.25pqΔTₜₛ.

The foregoing method of the present disclosure may be applicable to all the video frames, and particularly applicable to I frame. Problems, such as video pause, resulted from transmission delay of I frame may be solved. And fluency of video playing may be improved.

The method of the present disclosure will be described in the following in detail, accompanying with attached figures and various embodiments.

In the embodiment, smoothing I video frame transmitted in real time under a wireless network may be taken as an example. In the embodiment, a real-time video transmission may be executed from communication device A to communication device B. And then the video may be processed at the receiver device B. Specific process may be as follows.

(1) Communication device A may package and transmit bit stream, which has been collected and encoded. Each packet may carry timestamp information of each frame.

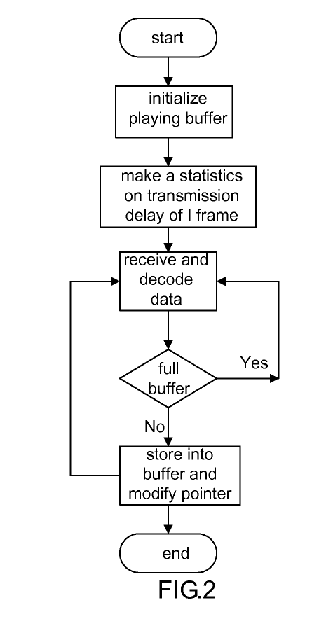

(2) FIG. 2 is a flowchart illustrating decoding and storing executed by a receiver device B, in accordance with an example of the present disclosure. As shown in FIG. 2, communication device B may start to receive, initialize a playing buffer, make a statistics on transmission delay Dᵢ of each I frame, reorder and then decode received packets.

(3) Decoded video frames may be stored in a ring buffer. A frame to be buffered, decoding of which is just finished, may enter the ring buffer from tail, and pointer of the frame may be tail. A frame to be played may be outputted from head of the ring buffer, and pointer thereof may be head. As shown in FIG. 2, after a frame is decoded, whether the buffer is full may be firstly determined. When determining that the buffer is full, tail pointer may be not changed, and the frame may not be stored; otherwise, the frame may be put into the buffer, and pointer pointing to the frame may be set to be tail.

(4) Set a statistical time window, size of which is time T. The statistical time window is used to average weighted transmission delay of each I frame within recent time T, to obtain transmission delay

$$D = \frac{{\sum }_{i = 1}^{N} {a}_{i} {D}_{i}}{N}$$

within recent time T. aᵢ(i=1, 2, . . . , N) may be a weight factor.

(5) Set a start playing threshold. When buffered frame number achieves the start playing threshold, start displaying. Meanwhile, local time T_{local}_{_{—}}_{base} displaying a first frame and transmitting timestamp Tₜₛ_{_{—}}_{base} of the first frame may be recorded. As a benchmark, control of displaying time of subsequent frames may be executed.

(6) Adjustment period of fast forwarding and slow playing may be set, the smallest value of which may be an interval of a video frame. In the example, adjustment period of fast forwarding and slow playing may be set to be T1. And then, it may make a statistics on transmission delay D every other T1 time. State of wireless network before arrival of a next period may be estimated, by using statistical transmission delay D_{curr} of recent period and statistical transmission delay Dₗₐₛₜ of last period. Compare statistical transmission delay D_{curr} of recent period and statistical transmission delay Dₗₐₛₜ of last period. When D_{curr}>Dₗₐₛₜ, it may denote that delay of I frame becomes larger, and network state may become worse. Thus, it is necessary to dynamically increase size of the playing buffer, so as to deal with large fluctuations in the network. When Dₗₐₛₜ>D_{curr}, it may denote that network state may become better. Thus, size of playing buffer may be dynamically adjusted to be smaller, so as to reduce playing delay to the largest extent. Value of T1 may be equal to, or greater than, or less than T. Specific value of T1 may be determined based on practical requirements.

(7) Fast forwarding and slow playing may be adjusted every other T1 time. Size of playing buffer may be increased or reduced by slow playing or fast forwarding of small granularity. Rate of slow playing or fast forwarding may be co-determined by variation of transmission delay, depth of playing buffer, and timestamp information of I frame. In the example, for each period, playing interval of each frame may be adjusted by adjusting local time T_{local}_{_{—}}_{base} for displaying the first frame.

(8) Perform a determination about displaying. Set a timer in a displaying thread, so as to query for displaying time periodically.

Compute within each timing period. Compute a difference Δt between current time and local time T_{local}_{_{—}}_{base}_{_{—}}_{new} displaying a first frame, after being adjusted with fast forwarding or slow playing. Compute a difference Δts between a transmission timestamp of a frame to be displayed or played currently and a transmission timestamp Tₜₛ_{_{—}}_{base} of the first frame. When Δt>Δts, display the frame to be displayed. Meanwhile, set the pointer of a next frame of the to-be-displayed frame buffered to be head.

For example, regarding a frame to be displayed currently, when the frame is located in a slow-playing adjustment period, corresponding T_{local}_{_{—}}_{base}_{_{—}}_{new} may be as follows. T_{local}_{_{—}}_{base}_{_{—}}_{new}=T_{local}_{_{—}}_{base}+0.25pq_{slow}·ΔTₜₛ. When the frame is located in a fast-forwarding adjustment period, corresponding T_{local}_{_{—}}_{base}_{_{—}}_{new} may be as follows. T_{local}_{_{—}}_{base}_{_{—}}_{new}=T_{local}_{_{—}}_{base′}−0.25pq_{fast}·ΔTₜₛ. When the foregoing frame is a second frame in the whole video stream, T_{local}_{_{—}}_{base′} may be the T_{local}_{_{—}}_{base} mentioned in block (5); otherwise, T_{local}_{_{—}}_{base′} may be T_{local}_{_{—}}_{base}_{_{—}}_{new} of a previous frame.

It should be noted that: 1: it is necessary to set a timing interval (T2) of timer to be smaller than interval of timestamp of two adjacent frames. Accuracy of displaying time may be higher, accompanying with smaller timing interval set. Meanwhile, the timer may be woken up in a shorter time to query and display. And more central processing unit (CPU) resources may be consumed. 2: Displayed reference frame (that is, the first frame in block (5)) is variable. In some cases, such as picture switch, after the buffer is empty, displayed reference frame may be set once again, so as to reduce cumulative timing error.

In a word, by adopting the method of the present disclosure, it may make a statistics on transmission delay of video frame periodically. Changes of state of wireless network may be sensed based on a statistical result, so as to dynamically adjust size of playing buffer, find the best playing delay, thereby achieving smoothing effects. Subsequently, balance of real-time performance and fluency of video stream may be implemented. In addition, mechanism of slow playing or fast forwarding of small granularity may be employed. Rates of slow playing and fast forwarding may be dynamically controlled by the following information, such as variation of transmission delay, depth of playing buffer and timestamp information. Playing buffer may be quickly adjusted without affecting displaying effects of video. For an embedded system, based on a conventional method, since size of playing buffer may be not dynamically adjusted, storage space of device may be wasted. However, in the examples of the present disclosure, storage space of device may be better saved by reducing size of playing buffer appropriately.

The foregoing is preferred examples of the present disclosure, which is not for use in limiting the present disclosure. Any modifications, equivalent substitutions and improvements made within the spirit and principle of the present disclosure, should be covered by the protection scope of the present disclosure.

1. A code rate smoothing method for transmitting real-time video in a wireless network, comprising:
making a statistics on transmission delay of a video frame;
when the transmission delay becomes smaller, adjusting a size of a playing buffer to be smaller by fast forwarding;
when the transmission delay becomes larger, adjusting the size of the playing buffer to be larger by slow playing;
wherein rates of the fast forwarding and the slow playing are determined by variation of the transmission delay, depth of the playing buffer and timestamp information.

2. The method according to claim 1, wherein making a statistics on the transmission delay of the video frame comprises:
making a statistics on the transmission delay D of the video frame periodically, wherein
$$D = \frac{{\sum }_{i = 1}^{N} {a}_{i} {D}_{i}}{N} ,$$
N is a number of video frames arrived within a recent time T, Dᵢ is the transmission delay of each video frame arrived within the recent time T, aᵢ (i=1, 2, . . . , N) is a weight factor, and T is a preset size of a statistical time window.

3. The method according to claim 1, wherein when the transmission delay becomes smaller, adjusting the size of the playing buffer to be smaller by the fast forwarding, when the transmission delay becomes larger, adjusting the size of the playing buffer to be larger by the slow playing, comprise:
comparing first statistical transmission delay of a recent period with second statistical transmission delay of a previous period;
when the second statistical transmission delay of the previous period is larger, determining that the transmission delay becomes smaller, and adjusting the size of the playing buffer to be smaller by the fast forwarding;
when the first statistical transmission delay of the recent period is larger, determining that the transmission delay becomes larger, and adjusting the size of the playing buffer to be larger by the slow playing.

4. The method according to claim 1, wherein the rates of the fast forwarding and the slow playing are changed within a range of 25% of a timestamp-based playing rate.

5. The method according to claim 4, wherein the rate of the slow playing is r_{slow}=(1−0.25pq_{slow})rₙₒᵣₘₐₗ, the rate of the fast forwarding is r_{fast}=(1+0.25 pq_{fast})rₙₒᵣₘₐₗ, p is a factor reflecting the variation of the transmission delay,
$$p = \{ \begin{matrix}\vert \frac{{D}_{curr} - {D}_{last}}{{D}_{last}} \vert , \vert {D}_{curr} - {D}_{last} \vert < {D}_{last} \\ 1 , \vert {D}_{curr} - {D}_{last} \vert \geq {D}_{last}\end{matrix} ;$$
q_{slow} is a factor reflecting the depth of the playing buffer of the slow playing,
$${q}_{slow} = 1 - \frac{buffer\_num}{buffer\_max} ;$$
q_{fast} is a factor reflecting the depth of the playing buffer of the fast forwarding,
$${q}_{fast} = \frac{buffer\_num}{buffer\_max} ,$$
D_{curr} is the first statistical transmission delay of the recent period, Dₗₐₛₜ, is the second statistical transmission delay of the previous period, buffer_num is a size of a current playing buffer, buffer_max is a predetermined maximum size of the playing buffer, and rₙₒᵣₘₐₗ is the timestamp-based playing rate.

6. The method according to claim 1, wherein the fast forwarding and the slow playing are implemented by adjusting a playing interval of two adjacent frames.

7. The method according to claim 1, wherein the video frame is an I frame.

8. The method according to claim 2, wherein the video frame is an I frame.

9. The method according to claim 3, wherein the video frame is an I frame.

10. The method according to claim 4, wherein the video frame is an I frame.

11. The method according to claim 5, wherein the video frame is an I frame.

12. The method according to claim 6, wherein the video frame is an I frame.
